(19) United States
(12) Patent Application Publication
(10) Pub. No.: US 2005/0246200 A1
(43) Pub. Date: Nov. 3, 2005

(54) System, method, and computer program product for healthcare management

(75) Inventors: Wendy S. Thomson, Bloomfield Hills, MI (US); David R. Townsend, Bloomfield Hills, MI (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 10/980,877

(22) Filed: Nov. 3, 2004

Related U.S. Application Data
(60) Provisional application No. 60/567,686, filed on May 3, 2004.

(51) Int. Cl. G06F 17/60

(52) U.S. Cl. 705/2; 705/4

(57) ABSTRACT

A system and method for healthcare process re-engineering including a managed care non-hospital referral process. One embodiment includes a healthcare workflow manager, which manages the healthcare process and management of relevant healthcare data. Further, various embodiments utilize an electronic identifier “smartcard” for healthcare management or other electronic identifier fulfilling the same purpose of patient identification and access to appropriate database records.

### CROSS-REFERENCE TO OTHER APPLICATION

This application claims priority from U.S. Provisional Patent Application 60/567,686, filed May 3, 2004, which is hereby incorporated by reference.

### TECHNICAL FIELD OF THE INVENTION

The present invention is directed, in general, to managed healthcare.

### BACKGROUND OF THE INVENTION

A typical medical transaction requiring specialist referral and attendant lab work and pharmacological care includes much manual processing, redundant records, incomplete records held by primary-care physicians, and much human coordination, review and paperwork that today is only marginally improved by information technology. These typical processes are inefficient and costly.

There is a need in the art for a system and process for improved healthcare management.

### SUMMARY OF THE INVENTION

A preferred embodiment provides a system and method for healthcare process re-engineering including a managed care non-hospital referral process. One embodiment includes a healthcare workflow manager, which manages the healthcare process and management of relevant healthcare data. Further, various embodiments utilize an electronic identifier “smartcard” for healthcare management or other electronic identifier fulfilling the same purpose of patient identification and access to appropriate database records.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIGS. 1-8 depict various processes in accordance with a preferred embodiment of the present invention, and together form a broad overall process in accordance with a preferred embodiment;

FIG. 9 depicts a block diagram of a data processing system in which aspects of the preferred embodiments can be implemented; and

FIG. 10 depicts a block diagram of a data processing system network in which aspects of the preferred embodiments can be implemented.

### DETAILED DESCRIPTION OF THE INVENTION

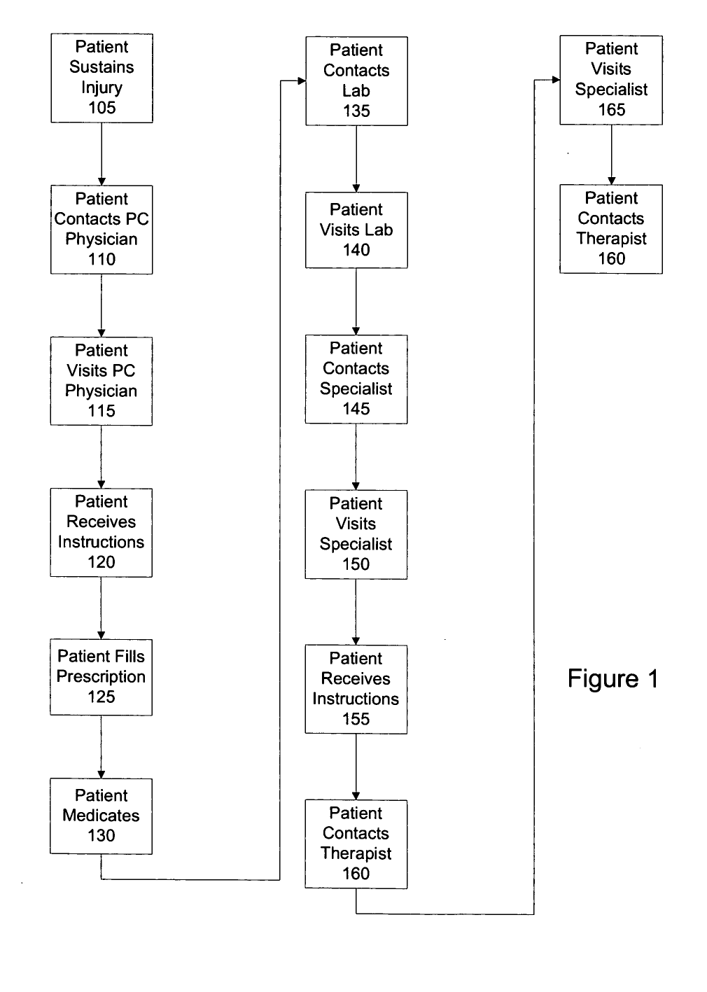

FIGS. 1 through 9 and the discussion below, and the various embodiments used to describe the principles of the present invention in this patent document, are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

A typical medical transaction requiring specialist referral and attendant lab work and pharmacological care includes much manual processing, redundant records, incomplete records held by Primary Care Physicians, and much human coordination, review and paperwork that today is only marginally improved by information technology.

A preferred embodiment provides a system and method for healthcare process re-engineering including a managed care non-hospital referral process. One embodiment includes a healthcare workflow manager, which manages the healthcare process and management of relevant healthcare data. Further, various embodiments utilize an electronic identifier “smartcard” for healthcare management.

A preferred embodiment includes a significant simplification of the current referral process, assisted by technologies such as smart card, web access, a rules-based workflow engine and large database management. Inherent in this embodiment are privacy and security provisions that render the system HIPAA-compliant via patient authorization, roles-based information viewing that matches records to be viewed with diagnostic codes authorized by the viewing doctor's specialty (e.g., orthopedic surgeons would view only those records stemming from orthopedic-related diagnoses), automated real-time insurance eligibility and authorization based upon parameter-driven rules tables, automated insurance reimbursement of medical professionals based upon services performed as approved by insurance eligibility tables, prescriptions accessed online by pharmacies, labs and other medical equipment and services providers, and rules-based automated referrals based upon lab results (e.g., if x-ray is positive then issue referral, etc.) A process flow of a preferred embodiment is shown the Figures. Not only can costs be significantly reduced, the quality of care delivered will increase, as the Primary Care Physician will have access to complete medical records, including prescriptions filled and care given by other medical professionals—information that today is most times incomplete and subject to human memory errors, as patients try to remember the what's, where's, and when's of previous and other-delivered care.

Currently, there are only limited and sporadic uses of Information Technology within the medical community: electronic submission of services rendered/billing statements (BCBS), voice-system tracking of procedures (Mayo Clinic), PDA-written and beamed prescriptions (niche product) and electronic tablets for medical notes (Henry Ford Health System). However, there is currently no comprehensive solution that takes a systems view of the process and systematically addresses the many interactions between the various medical stakeholders and removes non-value-added process steps and methods.

The attached figures illustrate various processes in accordance with a preferred embodiment. Following is a description of a process concerning an exemplary patient “Johnny”. Johnny uses a “smartcard”, in accordance with a preferred embodiment, to identify him, his records, and his coverage:

Johnny calls his primary care physician (PCP); Johnny visits PCP; Johnny swipes SmartCard; Authentication for care; PCP reads electronic records; PCP—Rx x-ray into system; PCP—Rx pain meds into system; PCP enters electronic record; Rules-based approval and electronic data interchange (EDI); Electronic lab scheduling; Johnny visits pharmacy; Johnny swipes card; Johnny picks up prescription; Record auto update; Rules-based approval and EDI; Johnny visits lab; Johnny swipes card; X-ray and results electronically stored; Rules-based approval and EDI; System notifies PCP/Johnny; Johnny calls specialist; Johnny visits specialist; Johnny swipes card; Specialist reads electronic x-rays; Specialist—Rx therapy into system; Specialist enters electronic record; Electronic therapist scheduling; Rules-based approval and EDI; Johnny visits therapist; Johnny swipes card; Therapist electronically enters record; Rules-based approval and EDI.

A preferred embodiment includes a “semi-smart” insurance card that would access electronically stored patient information, and includes some insurance information; a rules-based healthcare workflow manager that directs queries, verifies coverage, approves diagnoses/procedure codes for payment, electronically manages prescriptions, appropriately limits access to data, manages referrals, and generates provider payment authorization; and an underlying database, which is integrated with existing carrier databases, to support the healthcare workflow manager. Preferably, the medical record portion of the database adopts the HL7 EMR standard, known to those of skill in the art.

FIGS. 1-8 depict various processes in accordance with a preferred embodiment of the present invention, and together form a broad overall process in accordance with a preferred embodiment.

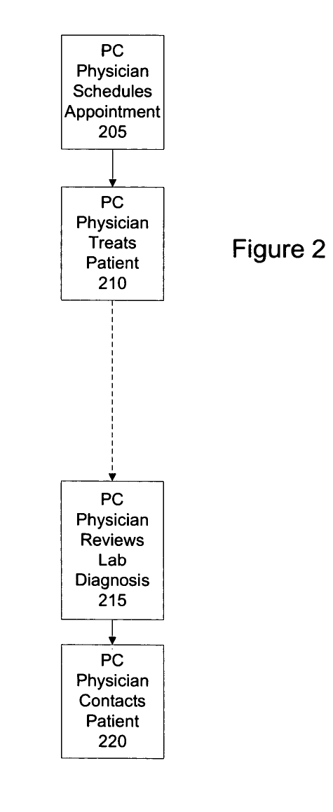

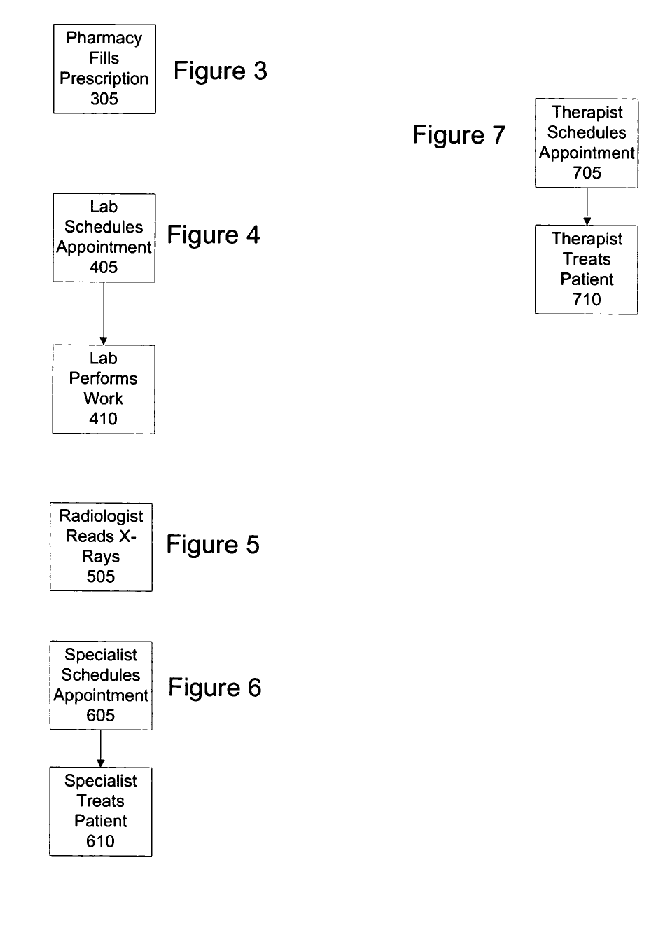

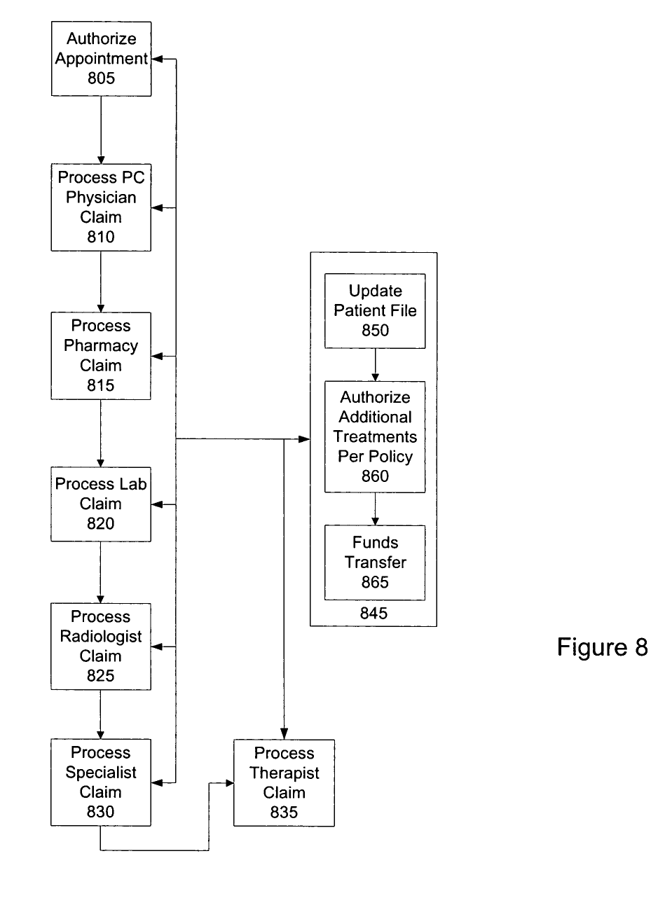

FIG. 1 depicts some actions performed by a patient with an injury; FIG. 2 depicts some actions performed by the patient's primary care physician; FIG. 3 depicts some actions performed by the patient's pharmacy; FIG. 4 depicts some actions performed by the patient's lab; FIG. 5 depicts some actions performed by the patient's radiologist; FIG. 6 depicts some actions performed by the patient's specialist physician; FIG. 7 depicts some actions performed by the patient's therapist; and FIG. 8 depicts some actions performed by a healthcare workflow manager. These various entities interact, and so the various figures will reference each other to describe a broad overall process. Of course, depending on any specific patient's ailment and treatment protocol, the specific actions taken by each entity may differ in practice, but fall within the scope of the invention.

FIG. 1 depicts some actions performed by a patient with an injury. Here, the patient first sustains an injury (step 105). Next, the patient contacts his primary-care physician (step 110), to schedule an appointment (205). It is assumed here that the patient is an existing patient of the primary-care physician. The patient, in preferred embodiments, has a smartcard that uniquely identifies him, and is used to identify his patient file in the healthcare database described below, which includes policy, coverage, and medical record information.

The healthcare database that includes the health records is preferably, and typically, separate from the database that holds policy and insurance coverage. The healthcare workflow manager, described more fully below, first pings an integrated insurer database (assumed existing) that holds policy and coverage information. If positive validation occurs, the patient is cleared for a covered visit. The healthcare workflow manager then retrieves the appropriate medical record and releases the medical record for viewing by the physician. The physician enters his diagnoses and procedure codes, plus any medical notes, into the healthcare workflow manager. The healthcare workflow manager reads provider information from the accessing terminal, picks up that demographic data along with the procedure and diagnoses codes, and compares it to the insurer policy and coverage. If positive match, then the claim approval is sent to insurer accounts payable system (assumed existing) for immediate electronic payment (EDI). The system can also send that financial information to a physician's automated financial system, if one exists in the physician's office. The healthcare workflow manager also populates the patient-owned database with the medical portion of the visit (no insurer-physician financial information, but the diagnostic and procedure codes and medical notes).

The preferred embodiment includes a single universal patient medical record, owned by the patient and to which provider access must be granted by the patient. The patient medical record, in the preferred embodiment, ensures that HIPAA privacy regulations are satisfied. This requires that HIPAA preferences are kept current, and that preferably only the patient can allow access to chosen providers.

The patient visits his primary care physician (step 115), and preferably uses his smartcard to identify him, his records, and his coverage. The patient pays the physician who provides care (210). The patient receives instructions from the physician (step 120).

If the patient has received a prescription from the physician, he will have it filled at the pharmacy (step 125, 305), where he will pay his copy and preferably present his smartcard to identify his benefits, co-pay, etc. The patient will take the prescribed medications (step 130).

If the patient also requires lab work, according to the physician, he will contact the lab (step 135) so schedule an appointment (405), and go to the lab (step 140) for examination, which in this example is an X-Ray (410). Again, the patient will preferably present his smartcard to identify his benefits, co-pay, etc.

If the patient also requires a specialist, according to the physician, he will contact the specialist (step 145) so schedule an appointment (605), and go to the specialist (step 150) for treatment (610). Again, the patient will preferably present his smartcard to identify his benefits, co-pay, etc. The patient will typically receive instruction from the specialist (step 155).

If the patient also requires a therapist, according to the physician or specialist, he will contact the therapist (step 160) so schedule an appointment (705), and go to the specialist (step 165) for treatment (710). Again, the patient will preferably present his smartcard to identify his benefits, co-pay, etc.

At this point, the patient should be fully treated for his injury. Of course, some steps above can be omitted or repeated as required by the injury and treatment plan.

FIG. 2 depicts some actions performed by the patient's primary care physician. Here, when the physician (or his office) is contacted by the patient (110), he schedules an appointment to see the patient (step 205). At the time of the scheduled visit, the physician will preferably use the healthcare workflow manager to authorize care (805), and to retrieve the patient file, as described below.

He then provides care to the patient (step 210), using information from the patient file received from a healthcare database. In the course of providing case, the doctor will preferably access the patient file, review the patient file, and assess the patient. The physician electronically records the diagnosis, procedures, and notes in a “services rendered” file to be stored in the healthcare database. The doctor, in this example, electronically authorizes any necessary prescriptions and labs (for example, an X-Ray). The diagnosis codes, procedure codes, prescriptions and lab authorizations are stored in the “services rendered” file in the healthcare database.

He receives payment from the patient (115), and preferably uses the smartcard to identify the patient, his records, and his coverage. A receipt is also electronically filed in the healthcare database. The physician will provide instructions to the patient (120).

Later, if the patient has gone to a lab, the physician will receive lab results from the healthcare workflow manager, and can also receive a referral authorization. The physician reviews the diagnosis from the lab (step 215), and contacts the patient (step 220) to relay the diagnosis and any further treatment instructions.

FIG. 3 depicts some actions performed by the patient's pharmacy. When the pharmacy is contacted by the patient (125) with a prescription, the pharmacy checks the electronic prescription in the patient file in the healthcare database. The pharmacy fills the prescription (step 305).

FIG. 4 depicts some actions performed by the patient's lab, if the patient requires lab work. In this example, the patient needs X-Rays, but this process applies to other lab work as well. When contacted by the patient (135), the retrieves the patient file from the healthcare database, and schedules an appointment (step 405). The lab work is performed (X-Rays in this case) (step 410), and is noted as a “services rendered” in the patient file in the healthcare database. Any lab results, such as a digitized X-Ray film, are also stored in the patient file in the healthcare database. The workflow engine accumulates data as indicated in 0022 above, splits it in the same manner and sends relevant financial information to the insurer and physician financial systems and posts medical data to the private patient medical record.

FIG. 5 depicts some actions performed by the patient's radiologist, if the patient requires a radiologist, as in this example. After the patient has had the X-Rays, the radiologist is notified by the healthcare workflow manager (820) that the digitized X-Rays need to be read. The radiologist accesses the patient file in the healthcare database, containing the digitized X-Rays, and reads the X-Rays (step 505). The radiologist then stores his diagnosis, based on the X-Rays, back into the patient file in the healthcare database.

FIG. 6 depicts some actions performed by the patient's specialist physician, if, as in this example, a specialist physician is required. When the specialist is contacted by the patient (145), she will schedule the appointment (step 605), and retrieve the patient file from the healthcare database. The specialist will provide care (step 610), and will enter the services rendered, including diagnosis and procedure codes, prescriptions, and authorizations for further treatment such as therapy, into the patient file to be stored back in the healthcare database.

FIG. 7 depicts some actions performed by the patient's therapist, if, as in this example, a therapist is required. When the therapist is contacted by the patient (160), she will schedule the appointment (step 705), and retrieve the patient file from the healthcare database. The therapist will provide care (step 710), and will enter the services rendered, including diagnosis and procedure codes, into the patient file to be stored back in the healthcare database.

FIG. 8 depicts some actions performed by a healthcare workflow manager. Upon presentation of the insurance card at the point of service, the healthcare workflow manager will authorize (or refuse) the appointment based on the insurance policy (step 805). The authorization displayed to the primary-care physician's office and sent to the insurer system.

The carrier coverage/insurer database preferably is regularly updated from various employer coverage and eligibility databases.

Note that, in the preferred embodiments, the patient file and the information contained therein, is still subject to the control of the patient, and the patient can allow or deny access to any party, in accordance with convention and privacy rights.

Some of these steps are reflected in a subprocess 845 performed by the healthcare workflow manager. As the healthcare workflow manager manages the patient's care, in accordance with physician recommendations and insurance policy requirements, it repeatedly performs any necessary updating of the patient's file (step 850), authorization of additional treatments, prescriptions, or other healthcare-related expenses (step 855), and performs any necessary fund transfer for necessary payment or reimbursements (step 860). Any necessary steps of subprocess 845 are taken at each event during the patient's care, as described below and illustrated in FIG. 8, but the specific recitation of each step is omitted below for purposes of clarity and brevity.

When the services rendered by the patient's primary-care physician (210) are entered into the patient's file, the healthcare workflow manager will process the claim (step 810). In doing so, it will examine the services rendered and the policy, and enter various data into the healthcare database. In the patient file, the healthcare workflow manager will store the diagnosis, procedures, prescriptions, and updated running totals of patient payments, the costs of services received, etc. In a patient account file, the healthcare workflow manager will store any billing, co-pay, and other financial details. Preferably, the healthcare workflow manager will also initiate a funds transfer, from the insurance carrier to the physician/provider, to pay the physician according to the patient's insurance coverage.

When the patient's prescription is filled at the pharmacy (305), the healthcare workflow manager will process the claim (step 815). In doing so, it will examine the prescription and the policy, and enter various data into the healthcare database. In the patient file, the healthcare workflow manager will store the prescription status and updated running totals of patient payments, the costs of prescriptions received, etc. In a patient account file, the healthcare workflow manager will store any billing, co-pay, and other financial details. Preferably, the healthcare workflow manager will also initiate a funds transfer, from the insurance carrier to the pharmacy, to pay the pharmacy according to the patient's insurance coverage.

When the patient's lab work is done (410), which in this example is an X-Ray, the healthcare workflow manager will process the claim (step 820), and also will notify the radiologist that the X-Ray needs to be examined. In doing so, it will enter various data into the healthcare database. In the patient file, the healthcare workflow manager will store the lab results and updated running totals of patient payments, the costs of the lab work, etc. In a patient account file, the healthcare workflow manager will store any billing, co-pay, and other financial details. Preferably, the healthcare workflow manager will also initiate a funds transfer, from the insurance carrier to the lab, to pay the lab according to the patient's insurance coverage.

When the radiologist has completed his diagnosis (505), the healthcare workflow manager will process the claim (step 825). In doing so, it will examine the services rendered by the radiologist and the policy, and enter various data into the healthcare database. In the patient file, the healthcare workflow manager will store the prescription status and updated running totals of patient payments, the costs of the radiologist services, etc. In a patient account file, the healthcare workflow manager will store any billing, co-pay, and other financial details. Preferably, the healthcare workflow manager will also initiate a funds transfer, from the insurance carrier to the radiologist, to pay the radiologist according to the patient's insurance coverage.

When the patient receives treatment from the specialist, the healthcare workflow manager will process the claim (step 830). In doing so, it will examine the prescription and the policy, and enter various data into the healthcare database. In the patient file, the healthcare workflow manager will store the diagnosis and procedure codes, prescription authorizations, and updated running totals of patient payments, the costs of prescriptions received, etc. In a patient account file, the healthcare workflow manager will store any billing, co-pay, and other financial details. Preferably, the healthcare workflow manager will also initiate a funds transfer, from the insurance carrier to the specialist, to pay the specialist according to the patient's insurance coverage.

When the patient receives treatment from the therapist, the healthcare workflow manager will process the claim (step 835). In doing so, it will examine the prescription and the policy, and enter various data into the healthcare database. In the patient file, the healthcare workflow manager will store the diagnosis and procedure codes, prescription authorizations, and updated running totals of patient payments, the costs of prescriptions received, etc. In a patient account file, the healthcare workflow manager will store any billing, co-pay, and other financial details. Preferably, the healthcare workflow manager will also initiate a funds transfer, from the insurance carrier to the therapist, to pay the therapist according to the patient's insurance coverage.

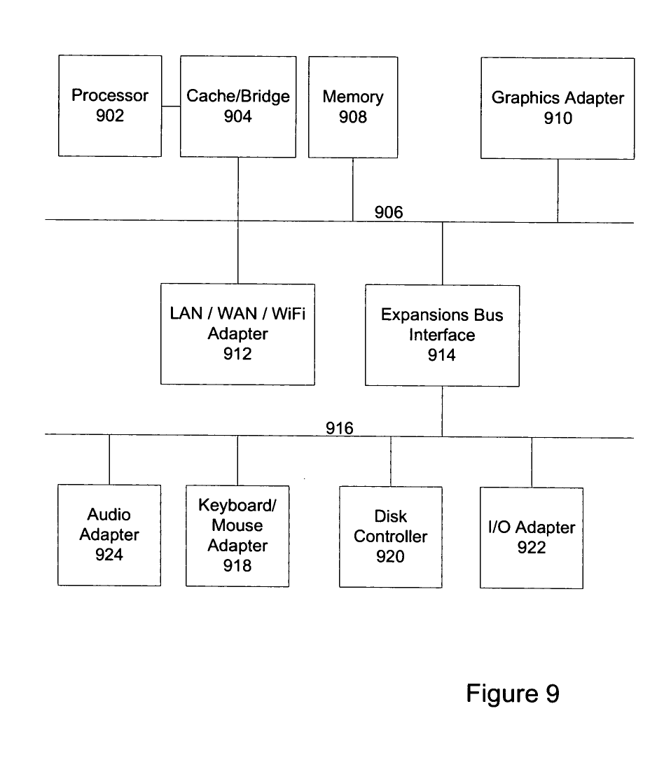

FIG. 9 depicts a block diagram of a data processing system in which a preferred embodiment can be implemented, as the data processing system in which the healthcare workflow manager is implemented, or as a data processing system used by one of the other entities above to interact with the healthcare workflow manager. The data processing system depicted includes a processor 902 connected to a level two cache/bridge 904, which is connected in turn to a local system bus 906. Local system bus 906 may be, for example, a peripheral component interconnect (PCI) architecture bus. Also connected to local system bus in the depicted example are a main memory 908 and a graphics adapter 910.

Other peripherals, such as local area network (LAN)/Wide Area Network/Wireless (e.g. WiFi) adapter 912, may also be connected to local system bus 906. Expansion bus interface 914 connects local system bus 906 to input/output (I/O) bus 916. I/O bus 916 is connected to keyboard/mouse adapter 918, disk controller 920, and I/O adapter 922.

Also connected to I/O bus 916 in the example shown is audio adapter 924, to which speakers (not shown) may be connected for playing sounds. Keyboard/mouse adapter 918 provides a connection for a pointing device (not shown), such as a mouse, trackball, trackpointer, etc. The data processing system can also include a storage for the healthcare database, or can be configured to communicate with the healthcare database.

Those of ordinary skill in the art will appreciate that the hardware depicted in FIG. 9 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

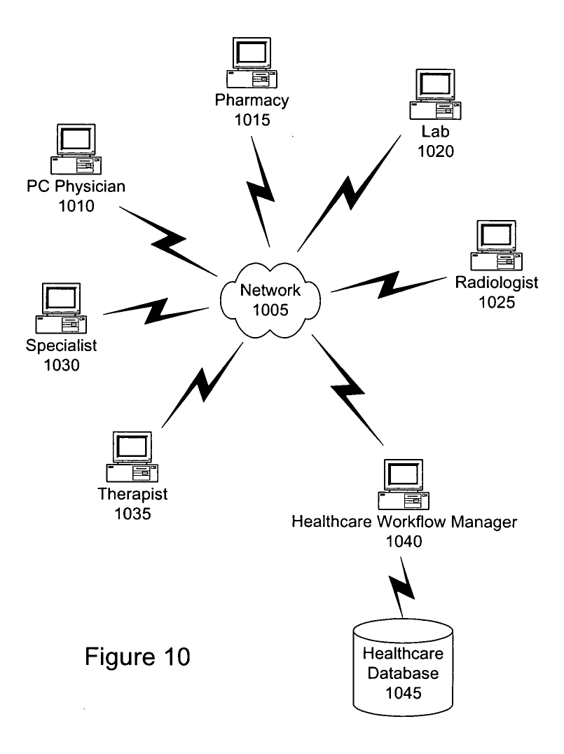

FIG. 10 depicts a data processing system network 1005, which can be the internet, and various interconnected data processing systems (DPS), in accordance with a preferred embodiment. Here, pharmacy DPS 1015, lab DPS 1020, radiologist DPS 1025, primary-care physician DPS 1010, specialist DPS 1030, and therapist DPS 1035 are all connected to communicate with healthcare workflow manager DPS 1040 over network 1005. Note that not all of these data processing systems are present or required in every implementation, but that the disclosed system and method becomes more efficient as it can be applied between more parties in the healthcare process.

Healthcare workflow manager DPS 1040 is configured to communicate with healthcare database 1045, as described above, and in some embodiments, healthcare database 1045 is physically stored in healthcare workflow manager DPS 1040.

One embodiment of the present invention includes a healthcare workflow management system, comprising: a patient file maintenance component configured to read and write from a database comprising multiple patient medical records, the patient medical records corresponding to individual patients; an insurance policy component configured to access health coverage policies corresponding to the individual patients; and a claims processing component configured to approve or deny healthcare benefits for individual patients according to the patient medical records and the health coverage policies, wherein the healthcare workflow management system is configured to selectively deliver information from the patient medical records to multiple healthcare providers; and selectively store information to the patient medical records according to treatment information received from the multiple healthcare providers.

Another embodiment of the present invention includes an automated method for managing healthcare, comprising: receiving a request for healthcare services from a healthcare provider, the request including a service identifier and a patient identifier; retrieving a patient medical record corresponding to the patient identifier; retrieving insurance coverage information corresponding to the patient identifier; selectively approving the request for healthcare services according to the patient medical record and the insurance coverage information; and transmitting a portion of the patient medical record to the healthcare provider.

Another embodiment of the present invention includes a computer program product tangibly embodied in a machine-readable medium, comprising: instructions for receiving a request for healthcare services from a healthcare provider, the request including a service identifier and a patient identifier; instructions for retrieving a patient medical record corresponding to the patient identifier; instructions for retrieving insurance coverage information corresponding to the patient identifier; instructions for selectively approving the request for healthcare services according to the patient medical record and the insurance coverage information; and instructions for transmitting a portion of the patient medical record to the healthcare provider.

The disclosed embodiments have many advantages, including but not limited to: The process builds upon good work already done designing a universal electronic medical record; The sum of patient-owned centralized records, integration of insurance eligibility and claims and a browser-accessed intelligent application agent enables elimination of non-value-added and costly administrative costs; The disclosed solution can be technically implemented using proven technology; Numerous conversations with medical providers suggest enthusiastic acceptance by the provider community; and several discussions with industry experts concur that the solution is feasible.

Various aspects of the invention have been disclosed, and those skilled in the art will recognize that, for simplicity and clarity, the full structure and operation of all systems and processes suitable for use with the present invention is not being depicted or described herein. Instead, only so much of a system as is unique to the present invention or necessary for an understanding of the present invention is depicted and described. The remainder of the construction and operation of a system may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A healthcare workflow management system, comprising:
a patient file maintenance component configured to read and write from a database comprising multiple patient medical records, the patient medical records corresponding to individual patients;
a insurance policy component configured to access health coverage policies corresponding to the individual patients; and
a claims processing component configured to approve or deny healthcare benefits for individual patients according to the patient medical records and the health coverage policies,
wherein the healthcare workflow management system is configured to
selectively deliver information from the patient medical records to multiple healthcare providers; and
selectively store information to the patient medical records according to treatment information received from the multiple healthcare providers.

2. The healthcare workflow management system of claim 1, further comprising payment processing means for processing payments to the healthcare provides according to the treatment information and the health coverage policies.

3. The healthcare workflow management system of claim 1, wherein individual patient medical records can be identified by a smartcard identifier carried by a patient.

4. The healthcare workflow management system of claim 1, wherein the healthcare providers include physicians.

5. The healthcare workflow management system of claim 1, wherein the healthcare providers include pharmacies.

6. The healthcare workflow management system of claim 1, wherein healthcare benefits must be approved before healthcare providers provide treatment.

7. The healthcare workflow management system of claim 1, wherein the healthcare workflow manager includes the database.

8. The healthcare workflow management system of claim 1, wherein the patient medical records include treatment and diagnostic codes.

9. The healthcare workflow management system of claim 1, wherein access into individual patient records is subject to approval by the patient.

10. The healthcare workflow management system of claim 1, wherein the healthcare workflow manager includes the database.

11. An automated method for managing healthcare, comprising:
receiving a request for healthcare services from a healthcare provider, the request including a service identifier and a patient identifier;
retrieving a patient medical record corresponding to the patient identifier;
retrieving insurance coverage information corresponding to the patient identifier;
selectively approving the request for healthcare services according to the patient medical record and the insurance coverage information; and
transmitting a portion of the patient medical record to the healthcare provider.

12. The method of claim 11, further comprising receiving patient treatment information from the healthcare provider, and storing the patient treatment information in the patient medical record.

13. The method of claim 11, further comprising processing a payment to the healthcare provider according to the insurance coverage information.

14. The method of claim 11, wherein the healthcare provider is a physician.

15. The method of claim 11, wherein the healthcare provider is a pharmacy.

16. The method of claim 11, wherein access to the patient medical record is subject to approval by the patient.

17. A computer program product tangibly embodied in a machine-readable medium, comprising:
instructions for receiving a request for healthcare services from a healthcare provider, the request including a service identifier and a patient identifier;
instructions for retrieving a patient medical record corresponding to the patient identifier;
instructions for retrieving insurance coverage information corresponding to the patient identifier;
instructions for selectively approving the request for healthcare services according to the patient medical record and the insurance coverage information; and
instructions for transmitting a portion of the patient medical record to the healthcare provider.

18. The computer program product of claim 17, further comprising instructions for receiving patient treatment information from the healthcare provider, and instructions for storing the patient treatment information in the patient medical record.

19. The computer program product of claim 17, further comprising instructions for processing a payment to the healthcare provider according to the insurance coverage information.

20. The computer program product of claim 17, wherein the healthcare provider is a physician.

21. The computer program product of claim 17, wherein the healthcare provider is a pharmacy.

22. The computer program product of claim 17, wherein access to the patient medical record is subject to approval by the patient.
